(19) United States
(12) Patent Application Publication
(10) Pub. No.: US 2010/0012069 A1
(43) Pub. Date: Jan. 21, 2010

(54) SEALING SYSTEM

(75) Inventor: Roger MÜLLER, Büttelborn (DE)

Correspondence Address: INGRASSIA FISHER & LORENZ, P.C. (GME), 7010 E. COCHISE ROAD, SCOTTSDALE, AZ, 85253, US

(73) Assignee: GM GLOBAL TECHNOLOGY OPERATIONS, INC., Detroit, MI (US)

(21) Appl. No.: 12/504,618

(22) Filed: Jul. 16, 2009

(30) Foreign Application Priority Data
Jul. 17, 2008 (DE) 102008033590.8

(51) Int. Cl. F02M 35/10

(52) U.S. Cl. 123/184.21; 277/591

(57) ABSTRACT

A sealing system is provided for connecting tubular motor vehicle components that includes, but is not limited to a connecting piece and a substantially tubular connecting attachment disposed radially outside the connecting piece. Disposed peripherally on an outer side of the connecting piece is a sealing element for sealing the connecting piece with respect to the connecting attachment. The sealing element has a receiving pocket for receiving the connecting attachment. Furthermore, a clamping element exerts a retaining force radially inwardly onto the connecting attachment by means of the sealing element. As a result, the connecting attachment can be connected to the connecting piece without an interposed hose so that the sealing system is space-saving and makes easier assembly possible.

### CROSS-REFERENCE TO RELATED APPLICATION

This application claims priority to German Patent Application No. 102008033590.8, filed Jul. 17, 2008, which is incorporated herein by reference in its entirety.

### TECHNICAL FIELD

The invention relates to a sealing system with the aid of which tubular motor vehicle components can be connected.

### BACKGROUND

In order to connect a charge air pipe for sucking in fresh air in a motor vehicle to a throttle pipe located upstream of a cylinder of an internal combustion engine for throttling the fresh air to be supplied, it is known to fasten a hose to a connecting attachment of the charge air pipe with the aid of a hose clip. The other end of the hose is connecting to a connecting piece of the throttle pipe with the aid of another hose clip.

A disadvantage with this type of sealing system is that a large amount of installation space is required and a plurality of handgrips and components are required to produce the respective connections. This makes assembly difficult and leads to higher manufacturing costs.

It is therefore at least one object of the invention to provide a sealing system for connecting tubular motor vehicle components, which is space-saving and which can be easily assembled. In addition, other objects, desirable features and characteristics will become apparent from the subsequent summary and detailed description, and the appended claims, taken in conjunction with the accompanying drawings and this background.

### SUMMARY

A sealing system according to an embodiment of the invention for connecting tubular motor vehicle components comprises a connecting piece, which can, for example, be a part of a throttle pipe. Disposed radially outside the connecting piece is a substantially tubular connecting attachment, which can, for example, be a part of a charge air pipe. Disposed peripherally on an outer side of the connecting piece is a peripheral sealing element for sealing the connecting piece with respect to the connecting attachment. The sealing element has a receiving pocket for receiving the connecting attachment. Also provided is a clamping element which exerts a retaining force radially inwardly onto the connecting attachment by means of the sealing element.

Due to the receiving pocket of the sealing element, it is possible to dispose the sealing element between the connecting piece and the connecting attachment and also between the connecting attachment and the clamping element. Direct contact of two rigid components is thereby avoided so that the sealing element can both protect the connecting piece, the connecting attachment and the clamping element and seal them with respect to one another. The receiving pocket is, for example, substantially U-shaped in cross section so that a single sealing element is sufficient to seal three different components with respect to one another. Due to the retaining force applied radially inwards by the clamping element, the clamping element initially presses against the sealing element which in turn presses against the connecting attachment. The connecting attachment in turn presses onto the connecting piece by means of the sealing element so that a high sealing effect and at the same time a frictional connection between the connecting piece and the connecting attachment is obtained. It is thereby possible to save a hose disposed between the connecting piece and the connecting attachment so that less material is required. Since no space need be made available for the hose, the sealing system makes possible a more compact structure which is space-saving. Furthermore, the connecting attachment can easily be placed on the connecting piece so that the sealing system can be simply and rapidly assembled. This facilitates handling and makes rapid assembly possible so that manufacturing costs are reduced.

The clamping element preferably exerts the retaining force peripherally in the circumferential direction. It is thereby possible to exert a retaining force of the same strength over the entire circumference of the connecting attachment. The clamping element is preferably designed as a hose clip. In the case of the hose clip, it is possible to gradually reduce the diameter of the clip opening formed by a band of the clip with the aid of a screw so that the retaining force can gradually be increased.

In a preferred embodiment, the connecting attachment is bendable in the radial direction. That is, the connecting attachment can elastically reduce its opening diameter to a specific extent. For this purpose, the connecting attachment in particular has at least one substantially axially disposed slit. A plurality of slits is preferably provided which are in particular distributed uniformly in the circumferential direction. This results in a plurality of wings which can each be bent somewhat inward so that the retaining force of the clamping element not only acts on the connecting attachment but also on the connecting piece. This results in a uniform sealing effect both on the connecting attachment and also on the connecting piece.

The connecting attachment preferably has at least one radially outwardly projecting stop for axial delimitation of the movement of the clamping element. The connecting attachment can, for example, have a peripheral elevation at its front-side or be bent outward. Even in the inserted state (i.e., when the connecting attachment is inserted in the receiving pocket of the sealing element), a radially outwardly pointing elevation is obtained as a result of the resilient, in particular, rubber-elastic material. The correct positioning of the clamping element can be ensured along this elevation. Furthermore, it is avoided that the clamping element can unintentionally slip down from the connecting attachment during assembly. Assembly errors and an inadequate sealing effect are thereby avoided.

In particular, the sealing element has at least one radially outwardly projecting sealing stop for axial delimitation of the movement of the clamping element. The sealing element can in particular have a peripheral recess for receiving the clamping element. The clamping element can thereby be inserted in a defined manner in the recess or be disposed along the sealing stop, in particular between two sealing stops which are preferably designed circumferentially. This results in a defined arrangement of the clamping element so that assembly errors and an inadequate sealing effect are reliably avoided.

Particularly preferably, the connecting piece has at least one radially outwardly projecting connecting piece stop for axial delimitation of the movement of the sealing element. This avoids the connecting element being pushed too forcibly onto the connecting piece. At the same time, the sealing element can abut against the connecting piece stop and thereby provide a seal in the axial direction. Furthermore, a springy damping can be provided by the sealing element so that vibrations can be damped and a perturbing rattling is avoided.

The sealing element preferably has a radially inwardly, in particular peripheral, sealing attachment for the front-sided abutment against the connecting piece. The sealing attachment avoids the connecting attachment being pushed too forcibly onto the connecting piece. Furthermore, a sealing effect can be provided in the axial direction as well as a springy damping.

The connecting piece and/or the connecting attachment are particularly preferably made of plastic and/or metal. It is not necessary to use soft and elastic materials to bring about a sufficient sealing effect between the connecting attachment and the connecting piece. In particular, the connecting piece can be connected in particular in one piece to a throttle pipe having a throttle flap. As a result, a single structural module is obtained for throttling the fresh air to be supplied, which can be built in a quite time-saving manner.

The invention further relates to an air intake pipe for an internal combustion engine of a motor vehicle, which has a charge air pipe for sucking in fresh air. The air intake pipe further comprises a throttle pipe which can be connected to a cylinder of the internal combustion engine for throttling the fresh air to be supplied. The throttle pipe can in particular comprise a throttle flap. The charge air pipe is connected to the throttle pipe by means of a sealing system, which can be configured and further developed as described hereinbefore. In this case, it is possible that the throttle pipe has the connecting piece and the charge air pipe has the connecting attachment or conversely. Since it is not necessary to dispose a hose between the charge air pipe and the throttle air pipe, the charge air pipe and the throttle pipe can be disposed close to one another so that a reduced installation requirement of installation space is required. Furthermore, as a result of the sealing system used the connection can be made simply and rapidly so that the assembly effort is reduced and manufacturing costs are lowered.

### BRIEF DESCRIPTION OF THE DRAWINGS

The embodiments of present invention will hereinafter be described in conjunction with the following drawing figures, wherein like numerals denote like elements, and:

FIG. 1 shows a schematic sectional view of an air intake pipe with the sealing system according to an embodiment of the invention;

FIG. 2 shows a schematic cutaway detailed view of the sealing system shown in FIG. 1; and

FIG. 3 shows a schematic perspective view of a charge air pipe of the sealing system from FIG. 1.

### DETAILED DESCRIPTION

The following detailed description is merely exemplary in nature and is not intended to limit application and uses. Furthermore, there is no intention to be bound by any theory presented in the preceding background and summary or the following detailed description.

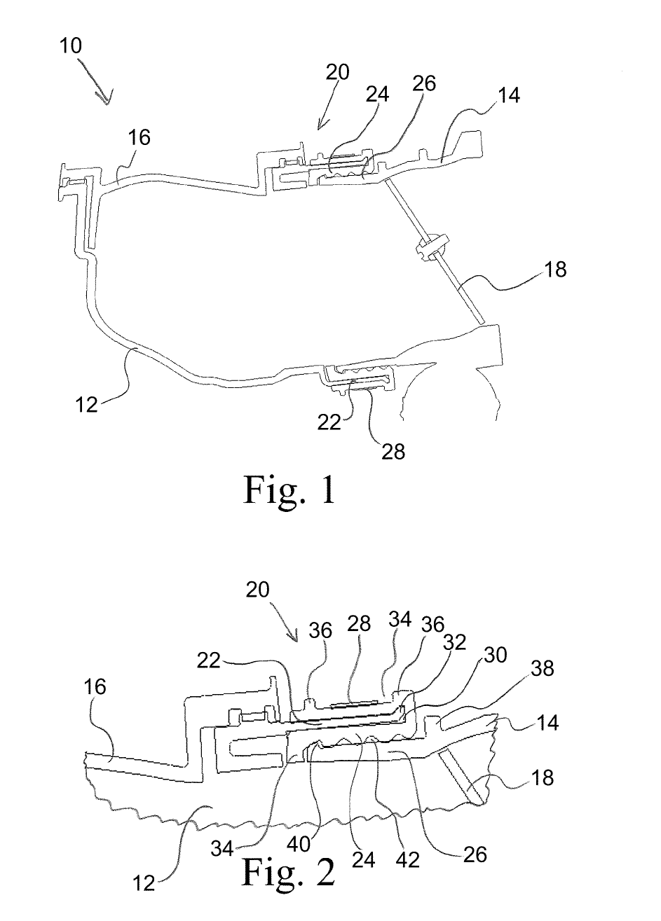

The air intake pipe 10 shown in FIG. 1 has a charge air pipe 12, which is connected to a throttle pipe 14. The charge air pipe 12 is multipart in the exemplary embodiment shown and has a cover 16 so that the interior of the charge air pipe 12 is accessible. The fresh air sucked in via the charge air pipe 12 can be throttled inside the throttle pipe 14 with the aid of a throttle flap 18.

The charge air pipe 12 is connected to the charge air pipe 12 by means of a sealing system 20 in a substantially airtight manner. For this purpose, the charge air pipe 12 has a connecting attachment 22 which is connected to a connecting piece 26 of the throttle pipe by means of a sealing element 24. The necessary retaining force is applied in the radial direction by means of a hose clip 28.

As shown in FIG. 2, the sealing element 24 has a receiving pocket 30, into which the connecting attachment 22 is inserted. As a result, the sealing element 24 is located both inside to the connecting attachment 22 and also outside to the connecting attachment 22. The hose clip 28 thus presses initially onto the upper region of the sealing element 24, which in turn presses onto the connecting attachment 22, which presses on the lower part of the sealing element 24 and from there onto the connecting piece 26.

The connecting attachment 22 has a radially outwardly protruding stop 32, which, in the inserted state, is disposed at the lowest and innermost position of the receiving pocket 30 and prevents the connecting attachment 22 from slipping out of the receiving pocket 30. The sealing element 24 has a recess 34, which is delimited in each case in the axial direction by a circumferential sealing stop 36 running in the peripheral direction. The clamping element 28 is disposed between the sealing stops 36 in the recess 34 and cannot accidentally slip out from the recess 34.

The sealing element 24 further comprises a radially inwardly pointing circumferential sealing attachment 34 running in the peripheral direction, which extends between the front sides of the connecting piece 26 and a part of the charge air pipe. This leads to a springy damping of vibrations between the charge air pipe 16 and the throttle pipe 14. The throttle pipe 14 or the connecting piece 26 have a radially outwardly pointing circumferential connecting piece stop 38 running in the peripheral direction, which prevents the connecting attachment 22 from being pressed too forcibly onto the connecting piece 26. The connecting piece 26 further has an undercut lug 40 on its front-side end, which can engage in corresponding receptacles 42. This leads to additional positioning fixing of the sealing system 20 in the axial direction.

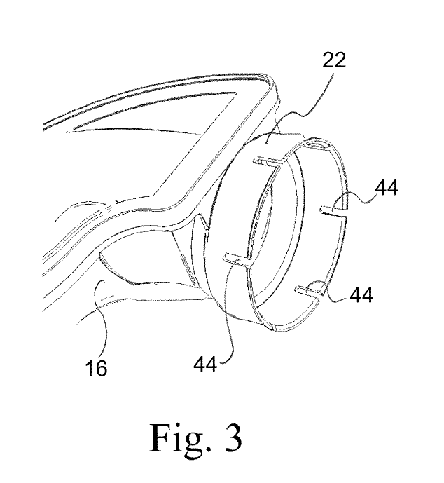

As shown in FIG. 3, the connecting attachment 22 of the charge air pipe 16 has a plurality of slits 44 extending in the axial direction, which extends as far as the front side of the connecting attachment 22. Due to the slits 44 it is possible to bend the connecting attachment 22 radially inward in the region between the slits 44 and thus elastically reduce the opening diameter of the connecting attachment 22 to some extent.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A sealing system for connecting tubular motor vehicle components, comprising:
a connecting piece;
a substantially tubular connecting attachment disposed radially outside the connecting piece;
a sealing element disposed peripherally on an outer side of the connecting piece for sealing the connecting piece with respect to the substantially tubular connecting attachment;
a receiving pocket of the sealing element adapted to receive the substantially tubular connecting attachment; and
a clamping element adapted to exert a retaining force radially inwardly onto the substantially tubular connecting attachment via the sealing element.

2. The sealing system according to claim 1, wherein the clamping element is adapted to exert the retaining force peripherally in a circumferential direction and the clamping element is a hose clip.

3. The sealing system according to claim 1, wherein the substantially tubular connecting attachment is bendable in a radial direction and comprises at least one substantially axially disposed slit.

4. The sealing system according to claim 1, wherein the substantially tubular connecting attachment comprises at least one radially outwardly projecting stop for axial delimitation of a movement of the clamping element.

5. The sealing system according to claim 1, wherein the sealing element comprises at least one radially outwardly projecting sealing stop for axial delimitation of a movement of the clamping element.

6. The sealing system according to claim 1, wherein the sealing element comprises a peripheral recess for receiving the clamping element.

7. The sealing system according to claim 1, wherein the connecting piece comprises at least one radially outwardly projecting connecting piece stop for axial delimitation of a movement of the sealing element.

8. The sealing system according to claim 1, wherein the sealing element comprises a radially inwardly sealing attachment for a front-sided abutment against the connecting piece.

9. The sealing system according to claim 1, wherein the connecting piece is made of plastic.

10. The sealing system according to claim 1, wherein the connecting piece is connected in one piece to a throttle pipe comprising a throttle flap.

11. An air suction pipe for an internal combustion engine of a motor vehicle, comprising:
a charge air pipe adapted to suck in air;
a throttle pipe adapted for connection to a cylinder of the internal combustion engine for throttling the air;
a sealing system adapted to connect the charge air pipe to the throttle pipe, the sealing system comprising:
a connecting piece;
a substantially tubular connecting attachment disposed radially outside the connecting piece;
a sealing element disposed peripherally on an outer side of the connecting piece for sealing the connecting piece with respect to the substantially tubular connecting attachment;
a receiving pocket of the sealing element adapted to receive the substantially tubular connecting attachment; and
a clamping element adapted to exert a retaining force radially inwardly onto the substantially tubular connecting attachment via the sealing element.

12. The air suction pipe according to claim 11, wherein the clamping element is adapted to exert the retaining force peripherally in a circumferential direction and the clamping element is a hose clip.

13. The air suction pipe according to claim 11, wherein the substantially tubular connecting attachment is bendable in a radial direction and comprises at least one substantially axially disposed slit.

14. The air suction pipe according to claim 11, wherein the substantially tubular connecting attachment comprises at least one radially outwardly projecting stop for axial delimitation of a movement of the clamping element.

15. The air suction pipe according to claim 11, wherein the sealing element comprises at least one radially outwardly projecting sealing stop for axial delimitation of a movement of the clamping element.

16. The air suction pipe according to claim 11, wherein the sealing element comprises a peripheral recess for receiving the clamping element.

17. The air suction pipe according to claim 11, wherein the connecting piece comprises at least one radially outwardly projecting connecting piece stop for axial delimitation of a movement of the sealing element.

18. The air suction pipe according to claim 11, wherein the sealing element comprises a radially inwardly sealing attachment for a front-sided abutment against the connecting piece.

19. The air suction pipe according to claim 11, wherein the connecting piece is made of plastic.

20. The air suction pipe according to claim 11, wherein the connecting piece is connected in one piece to the throttle pipe comprising a throttle flap.
